(19) United States
(12) Patent Application Publication
(10) Pub. No.: US 2009/0168639 A1
(43) Pub. Date: Jul. 2, 2009

(54) SPINDLE MOTOR AND DISK DRIVE APPARATUS PROVIDED WITH THE SAME

(75) Inventors: Takehito TAMAOKA, Kyoto (JP); Shingo SUGINOBU, Kyoto (JP); Mitsuhiro TAKEMOTO, Kyoto (JP); Genki TANAKA, Kyoto (JP); Toshihiro HIRASAWA, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Minami-ku (JP)

(21) Appl. No.: 12/342,242

(22) Filed: Dec. 23, 2008

(30) Foreign Application Priority Data
Dec. 26, 2007 (JP) 2007-333491
Apr. 22, 2008 (JP) 2008-111114

(51) Int. Cl. G11B 23/00

(52) U.S. Cl. 369/270.1; G9B/23

(57) ABSTRACT

A spindle motor includes a rotor unit rotatably supported by a bearing portion arranged to rotate about a central axis, a stator radially opposed to the rotor magnet with a gap therebetween and a substantially ring-shaped magnetic member arranged within a gap at an axial space between a disk and coil layers of the stator. The magnetic member includes a first planar portion and a second planar portion formed in a region overlapping with a moving region of a head unit, the first planar portion being positioned higher than the second planar portion. A carriage unit arranged to support the head unit may be accommodated within a space defined by the radial outer surface of the first planar portion, the upper surface of the second planar portion and the lower surface of the disk. Further, the coil layers can be made radially non-uniform in conformity with the shape of the magnetic member.

### BACKGROUND OF THE INVENTION

1. Field of the Invention

The present invention relates to a spindle motor and a disk drive apparatus provided with the same.

2. Description of the Related Art

In recent years, along with the reduction in size and thickness of a storage disk drive apparatus which is used to drive a storage medium such as magnetic disk, optical disk or the like used in personal computers, car navigations and so forth, there is an increasing demand for size reduction, particularly thickness reduction of a motor built in the disk drive apparatus. The motor of this kind is classified into an inner rotor type in which a rotor is rotated on the radially inner side of a stator and an outer rotor type in which a rotor is rotated on the radially outer side of a stator. In the following description, description will be made on an inner rotor type spindle motor.

In a conventional inner rotor type spindle motor, a magnetic shield member is arranged above a stator to prevent the magnetic flux mainly generated in the stator during a rotary driving operation from flowing toward the region above the magnetic shield member in a large quantity. Such a conventional spindle motor is disclosed in, e.g., International Publication No. 2000/62404.

In case of performing the thickness reduction of a spindle motor, there is a need to reduce the height of a storage disk. Since a magnetic shield member is arranged above a stator, however, it is impossible to arrange, in a lower potion, a head unit for reading and writing information from and on the storage disk and a carriage unit for supporting the head unit, which is rotatable about a rotational axis.

Since the magnetic shield member is formed into two stages in a circumferential direction and since the inner circumferential surface of the magnetic shield member radially spaced apart from and opposed to a rotor magnet has a step-like irregular shape, the magnetic attraction force becomes unstable when the motor is rotatingly driven, which leads to unstable rotation of a rotor unit. Consequently, it is sometimes the case that there are generated defects such as a positioning error signal, a puretone and a repeatable run-out.

The positioning error signal means that a head fails to follow the track of a storage disk and becomes unable to proficiently read and write information from and on the storage disk. The puretone refers to an abnormal noise generated by sympathetic vibrations of a stator and a rotor unit. The repeatable run-out signifies the vibration of a synchronous component of a shaft during the operation of a motor.

### SUMMARY OF THE INVENTION

In order to overcome the problems described above, preferred embodiments of the present invention provide a spindle motor for use in a disk drive apparatus which includes a head unit arranged to read information from a data storage medium and/or write information on the data storage medium, and a moving unit arranged to move the head unit across a planar surface of the disk.

The spindle motor preferably includes a rotor unit, a stator and a substantially ring-shaped magnetic member. The rotor unit preferably includes a rotor magnet and a disk mounting portion at which the disk is mounted. The stator includes a plurality of teeth radially arranged around a central axis and a plurality of coil layers formed by winding a conductive line on the respective teeth.

The magnetic member is preferably arranged within a small axial gap between the disk and the coil layers. The head unit spaced apart from and opposed to the magnetic member moves over and across the magnetic member in a radial direction. The magnetic member preferably includes a first planar portion and a second planar portion, both of which are arranged in an area overlapping with the movement region of the head unit. The first planar portion and the second planar portion preferably differ in their axial height from each other. The first planar portion is positioned higher than the second planar portion.

With the spindle motor of the preferred embodiments, a carriage unit can be accommodated within a space defined by the radial outer surface of the first planar portion of the magnetic member, the upper surface of the second planar portion of the magnetic member and the lower surface of the disk. Therefore, it becomes possible to make the spindle motor thin in an axial direction, which assists in reducing the thickness and size of the spindle motor.

In a spindle motor of another preferred embodiment of the present invention, the magnetic member has a first planar portion, a second planar portion and a third planar portion.

The first planar portion preferably includes a planar surface extending generally perpendicularly with respect to the central axis and is arranged to have a generally uniform axial height along a circumferential direction. The second planar portion is preferably arranged radially outwardly of the first planar portion in an area overlapping with the movement region of the head unit. The third planar portion is contiguous to the second planar portion in the circumferential direction and is arranged radially outwardly and axially upwardly of the first planar portion.

With the spindle motor of this preferred embodiment of the present invention, the inner circumferential surface of the magnetic member spaced apart from and opposed to the outer circumferential surface of a rotor magnet includes an axial height which is uniform in the circumferential direction. This stabilizes the magnetic attraction force in the course of rotatingly driving the motor, which in turn assures stable rotation of the rotor unit and makes it possible to prevent occurrence of defects such as a positioning error signal, a puretone and a repeatable run-out.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic sectional view taken along a plane containing a central axis of a disk drive apparatus having a spindle motor in accordance with one preferred embodiment of the present invention.

FIG. 2 is a schematic top plan view showing a preferred internal structure of the disk drive apparatus.

FIG. 3 is a schematic sectional view showing a portion of the spindle motor taken along a plane containing the central axis of the spindle motor in accordance with one preferred embodiment of the present invention.

FIG. 4 is a schematic sectional view taken along a plane containing the central axis of the spindle motor showing radial and thrust dynamic bearings of the spindle motor in accordance with one preferred embodiment of the present invention.

FIG. 5 is a schematic plan view showing a stator of the spindle motor in accordance with one preferred embodiment of the present invention.

FIGS. 6A, 6B and 6C each are schematic views showing an assembly process of a bridging wire holding jut portion.

FIG. 7 is a schematic view showing a magnetic shield member in accordance with one preferred embodiment of the present invention.

FIG. 8 is a schematic view showing a magnetic shield member in accordance with one preferred embodiment of the present invention.

FIG. 9 is a schematic top plan view showing the magnetic shield member shown in FIG. 7, which is arranged on the stator.

FIG. 10 is a schematic view showing the magnetic shield member having an insulation layer coated on the lower surface thereof.

FIG. 11 is a schematic sectional view taken along a plane containing the central axis of the spindle motor showing a spindle motor having coil layers whose thickness is uniform along a radial direction.

FIG. 12 is a schematic view showing coil layers arranged below a second planar portion of the magnetic shield member in accordance with one preferred embodiment of the present invention.

FIG. 13 is a schematic top plan view showing an internal structure of the disk drive apparatus provided with the magnetic shield member shown in FIG. 7, with the disks removed for clarity.

FIG. 14 is a schematic top plan view showing an internal structure of the disk drive apparatus provided with the magnetic shield member shown in FIG. 8, with the disks removed for clarity.

FIG. 15 is a schematic top plan view of the disk drive apparatus corresponding to FIG. 2, with the disk removed for clarity.

FIG. 16 is a schematic sectional view taken along line B-B in FIG. 15.

FIG. 17 is a schematic view showing a magnetic shield member in accordance with one preferred embodiment of the present invention

FIG. 18 a schematic top plan view showing an internal structure of the disk drive apparatus provided with the magnetic shield member shown in FIG. 17, with the disks removed for clarity.

FIG. 19 is a schematic view showing an example of the magnetic shield member in accordance with one preferred embodiment of the present invention.

FIG. 20 is a schematic view showing an example of the magnetic shield member in accordance with one preferred embodiment of the present invention.

### DETAILED DESCRIPTION OF THE PREFERRED EMBODIMENTS

Hereinafter, preferred embodiments of the present invention will be described with reference to the accompanying drawings. In the description of the preferred embodiments of the present invention made herein, the terms, for example, “upper”, “lower”, “left” and “right” used in explaining the positional relationship and orientation of individual members are intended to designate the positional relationship and orientation in the drawings and not to designate the positional relationship and orientation when built in an actual device.

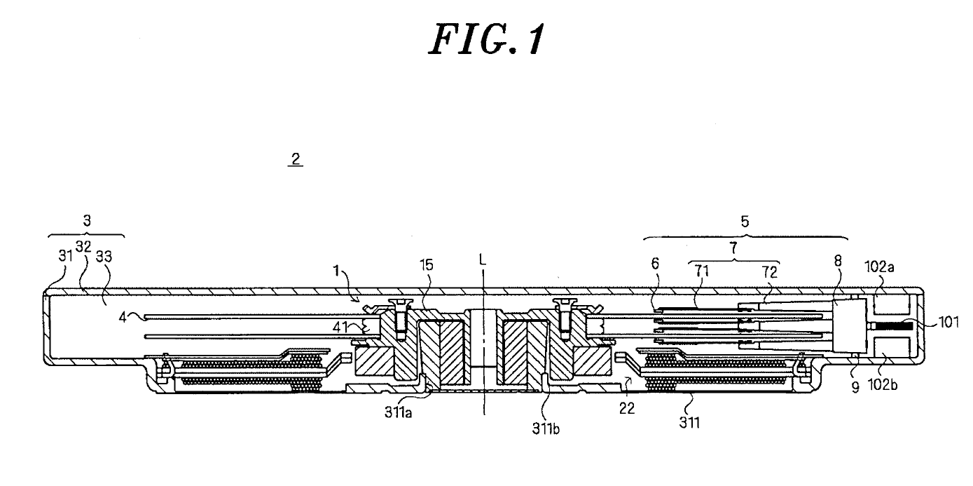

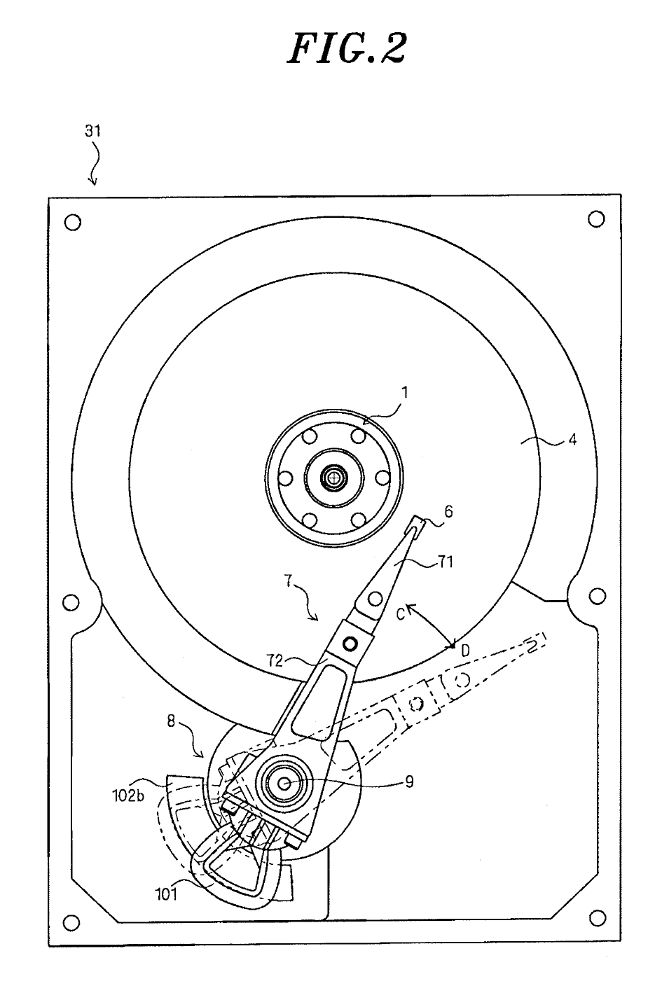

FIG. 1 is a sectional view taken along a plane containing a central axis of a disk drive apparatus 2 which preferably includes a spindle motor 1 in accordance with one preferred embodiment of the present invention. FIG. 2 is a top plan view showing the internal structure of the disk drive apparatus 2.

The disk drive apparatus 2 is a hard disk drive which preferably rotates a plurality (e.g., 2 in the present preferred embodiment) of data storage disks 4 and is preferably used to read information from the data storage disks 4 and write information on the data storage disks 4. As shown in FIG. 1, the disk drive apparatus 2 preferably includes an apparatus housing 3, the pair of storage disks (hereinafter simply referred to as “disks”) 4 such as magnetic disks or optical disks, the spindle motor 1 arranged to rotate the disks 4 at a specified speed, a plurality of head units 6 each arranged to read and/or write information from and/or on the disks 4, a carriage unit 7, which is preferably rotatable about a rotational axis, arranged to support the head units 6, and a swing unit 8 arranged to rotatingly drive the carriage units 7 and to position the head units 6 over the disks 4 so as to perform the reading and/or writing of information. The head units 6, the carriage unit 7 and the swing unit 8 preferably comprise an access unit 5.

The apparatus housing 3 preferably includes a cup-shaped first housing member 31 and a second housing member 32 having a substantially flat shape. The first housing member 31 preferably includes an upper opening. The second housing member 32 is preferably joined to the first housing member 31 so as to cover the upper opening of the first housing member 31. The apparatus housing 3 preferably includes an internal space 33 surrounded by the first housing member 31 and the second housing member 32. The disks 4, the access unit 5, a stator 22 and the spindle motor 1 are preferably accommodated in the internal space 33. The internal space 33 of the apparatus housing 3 is preferably a clean space.

The bottom surface of the first housing member 31 preferably includes a base 311 which is downwardly recessed and at which the spindle motor 1 and the stator 22 are preferably arranged. A through-hole 311a preferably extending through the base 311 along a central axis L is preferably arranged in the substantially central portion of the base 311. A substantially cylindrical holder portion 311b preferably protruding axially (which is a direction along the central axis L) is arranged outwardly (which is a direction with respect to the central axis L) of the through-hole 311a of the base 311. Although the present preferred embodiment assumes that the first housing member 31 and the base 311 are continuously arranged a single member, the first housing member 31 may be arranged independently of the base 311.

The disks 4 are preferably disk-shaped information storage media each having an opening at the substantially central portion thereof. The disks 4 are preferably mounted to a rotor hub 15 of the spindle motor 1 and are preferably arranged one above the other in a substantially parallel manner with a spacer 41 arranged therebetween.

The access unit 5 preferably includes the plurality (4 in the present preferred embodiment) of head units 6 respectively opposed to the corresponding upper and lower surfaces of the disks 4, the carriage units 7 arranged to support the respective head units 6, and the swing unit 8 fixed to the bottom surface of the first housing member 31 arranged to support the carriage units 7.

The carriage units 7 each preferably include a spring arm 71 to support the corresponding head unit 6 and a base arm 72 which supports the spring arm 71. Also, the carriage units 7 preferably are rotatably supported at a pivot shaft 9 and are moved (e.g., swing) about the pivot shaft 9 by a voice coil motor arranged at an opposite area of the base arm 72 with respect to the pivot shaft 9. The voice coil motor preferably includes a coil 101 which rotates with the carriage units 7, and magnets 102a and 102b which are affixed to an inner surface of the apparatus housing 3. The magnets 102a and 102b sandwich the coil 101 in the axial direction. The carriage units 7 and the voice coil motor preferably comprise the swing unit 8 (i.e., an actuator unit).

In the access unit 5, the voice coil motor is preferably driven by allowing an electric current to flow through the coil 101. In response, the four carriage units 7 are preferably moved along the disks 4 so that the four head units 6 gain access to the desired positions on the disks 4. Thus, the access unit 5 preferably performs reading and/or writing of information with respect to the corresponding surfaces of the respective disks 4. The carriage units 7 are preferably moved in the directions indicated by arrows C and D (see FIG. 2) by controlling the direction of the electric current flowing through the coil 101.

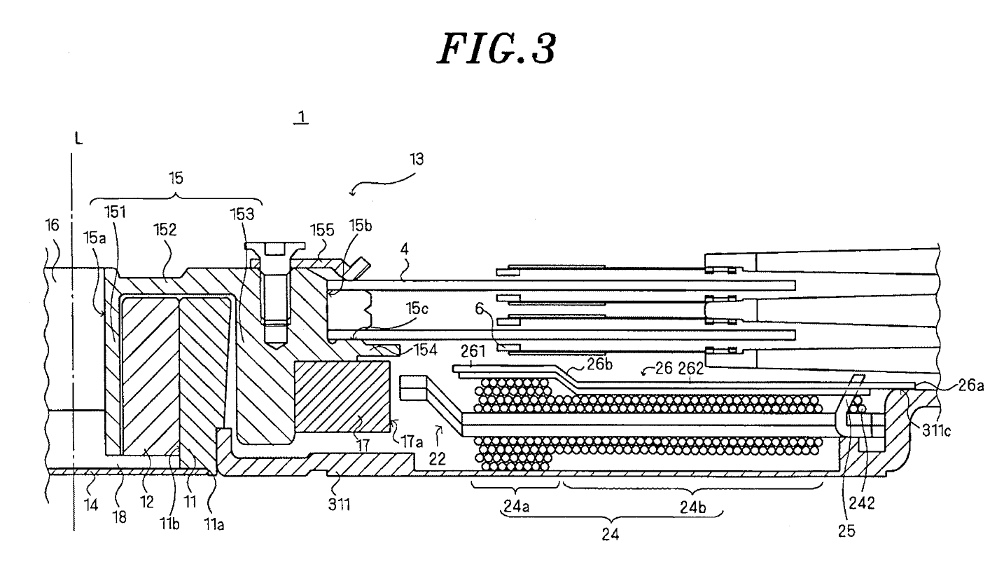

Next, description will be made on the configuration of the spindle motor 1. FIG. 3 is a sectional view, taken along a plane containing the central axis of the spindle motor 1, showing a portion of the spindle motor 1. As shown in FIG. 3, the spindle motor 1 of the present preferred embodiment preferably includes a bearing housing 11 fixed to the base 311, a sleeve 12 fixed to the inner circumferential surface of the bearing housing 11 and a rotor unit 13 rotatably supported by the sleeve 12.

The bearing housing 11 having a substantially hollow cylindrical shape preferably includes a counter plate 14 so as to close the axial lower end of the bearing housing 11. A cutout 11a is preferably arranged at the inner marginal portion of the lower planar surface of the bearing housing 11. The outer end portion of the counter plate 14 is preferably brought into contact with and adhesively fixed to the cutout 11a. The bearing housing 11 is preferably made of, e.g., stainless steel such as SUS303, SUS304 and SUS420J2, a resin material or the like.

The cylindrical sleeve 12 having a bearing bore which axially extends through the center thereof is preferably fixed to the inner circumferential surface lib of the bearing housing 11 by bonding or other fixing means. The sleeve 12 is preferably made of an oil-impregnated porous sintered material. Although the present preferred embodiment assumes that the material of the sleeve 12 is made of the oil-impregnated porous sintered, the present invention is not limited thereto; the sleeve 12 may be made by shaping and sintering a raw material such as metal powder, metallic compound powder or non-metallic powder. The raw material preferably contains, e.g., Fe—Cu, Cu—Sn, Cu—Sn—Pb, Fe—C and the like. Alternatively, the bearing housing 11 and the sleeve 12 may preferably be made of, e.g., copper, copper alloy or other materials. While the opening of the hollow cylindrical bearing housing 11 is preferably closed by fixing the counter plate 14 to the lower end of the housing 11 according to the present preferred embodiment, it may be possible to use a bearing housing seamlessly arranged with a counter plate, i.e., a cup-shaped bearing housing.

The rotor hub 15 preferably includes a shape extending radially outwardly around the shaft 16, i.e., the central axis L, of the spindle motor 1. A through-hole 15a which is preferably coaxial with the central axis L is arranged at the substantially center of the rotor hub 15. The rotor hub 15 is preferably fixed onto the shaft 16. To be more specific, the rotor hub 15 preferably includes a first cylinder portion 151 fixed onto the outer circumferential surface of the shaft 16, a planar surface portion 152 extending radially outwardly from substantially the upper end portion of the first cylinder portion 151 and a second cylinder portion 153 extending downwardly from the outer peripheral edge of the planar surface portion 152. The second cylinder portion 153 preferably includes an outer circumferential surface 15b which makes contact with the inner peripheral portions (the inner circumferential surfaces or the inner circumferential edges) of the disks 4. A radially outwardly protruding rest portion 154 (hereafter, a disk mounting portion) preferably having an upper flange surface 15c on which one of the disks 4 is arranged near the lower end portion of the second cylinder portion 153. The rotor hub 15 is preferably made of, e.g., stainless steel such as SUS420J2 or the like. Below the rest portion 154, a substantially ring-shaped rotor magnet 17 is preferably fixed to the outer circumferential surface of the second cylinder portion 153 by means of an adhesive agent or the like.

The rotor magnet 17 is, for example, a radial anisotropic or isotropic neodymium magnet having N-poles and S-poles alternately arranged in a circumferential direction. The direction of the magnetic flux of these magnetic poles preferably is substantially the same as the radial direction of the rotor magnet 17. The rotor magnet 17 is preferably positioned such that a gap is arranged between the outer circumferential surface 17a thereof and teeth 231 which will be described later.

The two disks 4 are preferably arranged one above the other on the flange surface 15c of the rotor hub 15 in a horizontal manner while maintaining a uniform interval therebetween. For example, the lower one of the disks 4 is preferably mounted on the flange surface 15c, while the remaining one (e.g., the upper one of the disks 4) is preferably mounted above the lower one with a spacer 41 interposed therebetween. The top surface of the upper one of the disks 4 is preferably pressed and arranged by a pressing member 155 attached to the planar surface portion 152 of the rotor hub 15. By virtue of such configuration, the disks 4 are preferably secured by the flange surface 15c of the rotor hub 15 and the pressing member 155 so as to rotate with the rotor hub 15 in a uniform manner.

The rotor unit 13 preferably includes the shaft 16 radially opposed to the inner circumferential surface of the sleeve 12 with a small gap therebetween, a ring-shaped and substantially disk-shaped thrust plate 18 extending radially outwardly from the lower outer circumferential surface of the shaft 16 and a rotor hub 15 having a substantially cup-shaped and seamlessly arranged with the shaft 16.

The shaft 16 preferably includes a substantially cylindrical shaped arranged along the central axis L. The first cylinder portion 151 of the rotor hub 15 preferably is radially opposed to the outer circumferential surface of the shaft 16 with a small gap therebetween. The lower end surface of the shaft 16 preferably extends slightly below the lower surface of the sleeve 12 in the axial direction.

The ring-shaped disk-like thrust plate 18 preferably extending radially outwardly from the outer circumferential surface of the shaft 16 is arranged below the sleeve 12 so that it can be axially opposed to the lower surface of the sleeve 12 with a small gap therebetween. The thrust plate 18 performs as a flange portion of the shaft 16. The thrust plate 18 preferably includes an outer diameter which is slightly smaller than that of the sleeve 12. While the present preferred embodiment assumes that the thrust plate 18 and the shaft 16 are arranged as a single member, the present invention is not limited thereto; the thrust plate 18 and the shaft 16 may be provided independently of each other and then fixed to each other. When the thrust plate 18 and the shaft 16 are provided independently of each other, the upper surface of the thrust plate 18 preferably makes contact with the lower end surface of the shaft 16 with no gap therebetween.

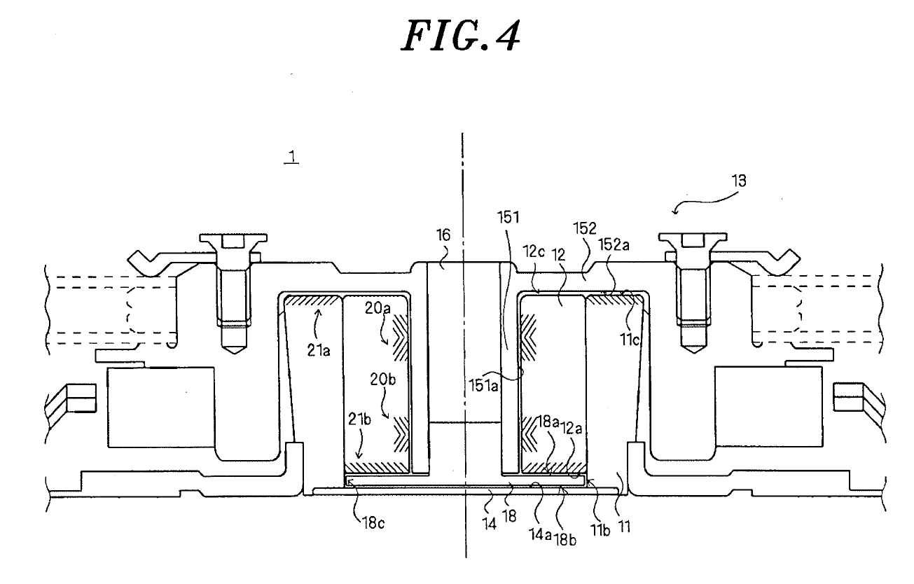

Next, the bearing structure will be described with reference to FIG. 4.

The thrust plate 18 preferably includes an upper surface 18a and a lower surface 18b axially opposed to the lower planar surface portion 12a of the sleeve 12 and the upper surface 14a of the counter plate 14, respectively, with small gaps therebetween. Also, the thrust plate 18 preferably includes an outer circumferential surface 18c radially opposed to the inner circumferential surface lib of the bearing housing 11 with a small gap therebetween. It is to be noted that while material used to make the thrust plate 18 may be selected in view of the mechanical strength and the dimensional stability as desired, since the thrust plate 18 is fixed to the end portion of the shaft 16 and is rotated together with the shaft 16, it is preferred that the thrust plate 18 is made of a material having the same thermal expansion coefficient as that of the shaft 16.

By virtue of such configuration, the small gap between the upper surface 11c of the bearing housing 11, the upper surface 122c of the sleeve 12 and the lower surface 152a of the planar surface portion 152 of the rotor hub 15, the small gap between the outer circumferential surface 151a of the first cylinder portion 151 of the rotor hub 15 and the inner circumferential surface 12b of the sleeve 12, the small gap between the lower surface 12a of the sleeve 12 and the upper surface 18a of the thrust plate 18, and the small gap between the upper surface 14a of the counter plate 14 and the lower surface 18b of the thrust plate 18 are in communication with one another. A lubricant, for example, lubricating oil 19, is preferably arranged in a continuous manner at the mutually communicating small gaps.

A radial dynamic pressure bearing portion arranged to support a radial load is preferably arranged at the small gap between the radial rotor-hub bearing surface positioned radially outwardly of the first cylinder portion 151 of the rotor hub 15 and the radial sleeve bearing surface of the sleeve 12 opposed to the radial rotor-hub bearing surface. Radial dynamic pressure groove arrays 20a and 20b having substantially a herringbone pattern in order to induce a dynamic fluid pressure in the lubricating oil 19 during rotation of the rotor hub 15 relative to the sleeve 12 are preferably arranged on at least one of the radial rotor-hub bearing surface and the radial sleeve bearing surface.

In the present preferred embodiment, the radial dynamic pressure groove arrays 20a and 20b having the herringbone pattern, each groove of which has a chevron shape (e.g., “<” shape), are preferably arranged one above the other at the inner circumferential surface 12b of the sleeve 12 in an axially spaced-apart relationship with each other. It is to be noted that the radial dynamic pressure groove arrays 20a and 20b are not limited to the herringbone pattern; a spiral pattern or a tapering land pattern may be used. Any groove pattern may be used insofar as it works as a dynamic fluid pressure bearing. While the radial dynamic pressure groove arrays 20a and 20b are arranged only at the radial sleeve bearing surface in the present preferred embodiment, they may be arranged on the radial rotor-hub bearing surface, i.e., on the outer circumferential surface 151a of the first cylinder portion 151 of the rotor hub 15. Furthermore, while the first cylinder portion 151 of the rotor hub 15 is preferably interposed between the sleeve 12 and the shaft 16 in the present preferred embodiment, the present invention is not limited thereto. The first cylinder portion 151 of the rotor hub 15 may be omitted, in which case a radial shaft bearing surface is preferably provided as a surface opposed to the radial sleeve bearing surface.

If the rotor hub 15 and the shaft 16 are rotated together with respect to the sleeve 12 by the rotation of the motor 1, a dynamic fluid pressure is induced in the lubricating oil 19 filled in the small gaps under the pumping action of the radial dynamic pressure groove arrays 20a and 20b. Consequently, the rotor hub 15 fixed to or seamlessly arranged with the shaft 16 is radially supported without making contact with the sleeve 12 and is rotatable with respect to the sleeve 12.

A thrust bearing portion is preferably arranged in the small gap between the thrust rotor-hub bearing surface substantially positioned on the lower side of the planar surface portion 152 of the rotor hub 15 and the thrust bearing-housing bearing surface positioned on the upper side of the bearing housing 11 and opposed to the thrust rotor-hub bearing surface. A thrust dynamic pressure groove array 21a of spiral pattern arranged to induce a dynamic fluid pressure in the lubricating oil 19 during rotation of the rotor hub 15 relative to the bearing housing 11 is preferably arranged on at least one of the thrust rotor-hub bearing surface and the thrust bearing-housing bearing surface.

Similarly, a thrust bearing portion is preferably arranged in the small gap between the thrust sleeve bearing surface positioned on the lower side of the of the sleeve 12 and the thrust thrust-plate bearing surface positioned on the upper side of the thrust plate 18 and opposed to the thrust sleeve bearing surface. A thrust dynamic pressure groove array 21b of spiral pattern arranged to induce a dynamic fluid pressure in the lubricating oil 19 during rotation of the thrust plate 18 relative to the sleeve 12 is arranged on at least one of the thrust sleeve bearing surface and the thrust thrust-plate bearing surface.

In the present preferred embodiment, the thrust dynamic pressure groove array 21a arranged to induce a dynamic fluid pressure in the lubricating oil 19 which is filled between the upper surface 11c of the bearing housing 11 and the upper surface 12c of the sleeve 12, extending radially outwardly from the central axis, is preferably arranged at the upper surface 11c of the bearing housing 11. Also, the thrust dynamic pressure groove array 21b arranged to induce a dynamic fluid pressure in the lubricating oil 19 filled between the lower surface 12a of the sleeve 12 and the upper surface 18a of the thrust plate 18, preferably extending radially outwardly from the central axis, is arranged on the lower surface 12a of the sleeve 12. While the thrust dynamic pressure groove array 21a is arranged on the thrust bearing-housing bearing surface and the thrust dynamic pressure groove array 21b is arranged on the thrust sleeve bearing surface in the present preferred embodiment, the thrust dynamic pressure groove array 21a may be arranged on the thrust rotor-hub bearing surface and the thrust dynamic pressure groove array 21b may be arranged on the thrust thrust-plate bearing surface. Furthermore, while the thrust bearing-housing bearing surface positioned on the upper side of the bearing housing 11 is used as a thrust bearing surface opposed to the thrust rotor-hub bearing surface in the present preferred embodiment, the thrust sleeve bearing surface positioned on the upper side of the sleeve 12 may be used as a thrust bearing surface opposed to the thrust rotor-hub bearing surface, in which case the thrust dynamic pressure groove array 21a may be arranged on the thrust sleeve bearing surface. In this regard, the thrust dynamic pressure groove array 21a may be arranged on one or both of the thrust bearing-housing bearing surface and the thrust sleeve bearing surface.

The rotor unit 13 is preferably pressed upwardly and downwardly by the lifting action of the thrust dynamic pressure groove array 21a against the rotor unit 13 and the push-down action of the thrust dynamic pressure groove array 21b against the thrust plate 18. The rotating and floating movement of the rotor unit 13 is preferably stabilized in the position where the upwardly and downwardly acting dynamic pressures are kept substantially in balance. Formation of the thrust dynamic pressure groove arrays 21a and 21b preferably ensures that the bearing forces generated by the thrust dynamic pressure groove arrays 21a and 21b act toward each other, which makes it possible to stably maintain the rotation of the rotor hub 15.

While the thrust dynamic pressure groove arrays 21a and 21b preferably include the spiral grooves in the present preferred embodiment, the present invention is not limited thereto. It may be possible to arranged herringbone grooves in one or both of the thrust dynamic pressure groove arrays 21a and 21b. In this case, it is preferred that the herringbone grooves arranged in the thrust dynamic pressure groove arrays 21a and 21b are substantially unbalanced so as to generate dynamic pressures acting to radially inwardly pump the lubricating oil 19. The radially inwardly acting dynamic pressures preferably increases the internal pressure of the oil existing radially inwardly of the unbalanced herringbone grooves, thereby substantially preventing creation of a negative pressure and generation of air bubbles.

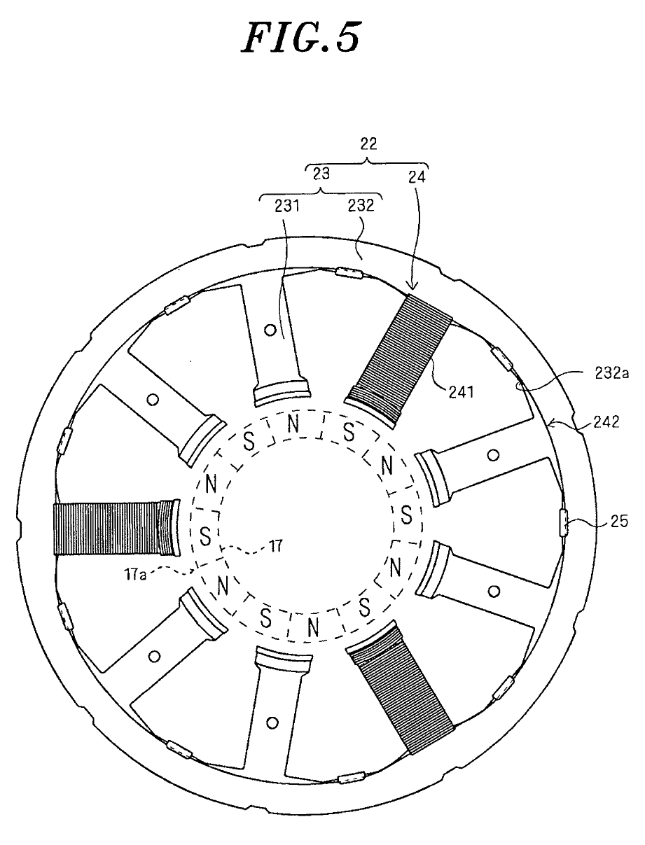

Next, the stator 22 fixed to the base 311 of the first housing member 31 will be described with reference to FIG. 5. The stator 22 preferably includes a stator core 23, which includes a plurality of teeth 231 radially arranged around the central axis with their tip ends facing toward the central axis and a substantially ring-shaped core-back 232 arranged to connect the radial outer end portions of the teeth 221 in a substantially equal interval, and a plurality of coil layers (coils) 24 arranged by winding a conductive line 241 on the respective teeth 231. The stator 22 is radially opposed to the outer circumferential surface 17a of the rotor magnet 17 with a small gap therebetween. The stator core 23 is preferably made from metal sheets, e.g., laminated steel plates, by axially laminating a plurality of electromagnetic steel plates such as substantially ring-shaped silicon steel plates or the like. In the present preferred embodiment, the stator core 23 is arranged by laminating two metal sheets 23a and 23b.

Near the inner circumference 232a of the core-back 232 between the two mutually neighboring teeth 231, there is provided a bridging wire holding jut portion 25 arranged to keep bridging wires 242 of the conductive line 242 from moving radially inwardly of the core-back 232. The jut portion 25 is preferably arranged by axially upwardly bending a protrusion which extends radially inwardly from the core-back 232. The bridging wires 242 are preferably arranged to extend from one of the coil layers 24 to another via the radial outer side of the jut portion 25. The jut portion 25 protruding from the core-back 232 preferably holds the conductive line 241 extending between the teeth 231. By virtue of such configuration, an additional synthetic resin ring which is usually arranged to hold bridging wires will not be necessary, which makes it possible to further reduce the thickness of stator 22.

While the coil layers 24 are shown in FIG. 5 as if they are arranged at three of the nine teeth 231, the coil layers 24 are also arranged at the remaining teeth 231 in the same manner.

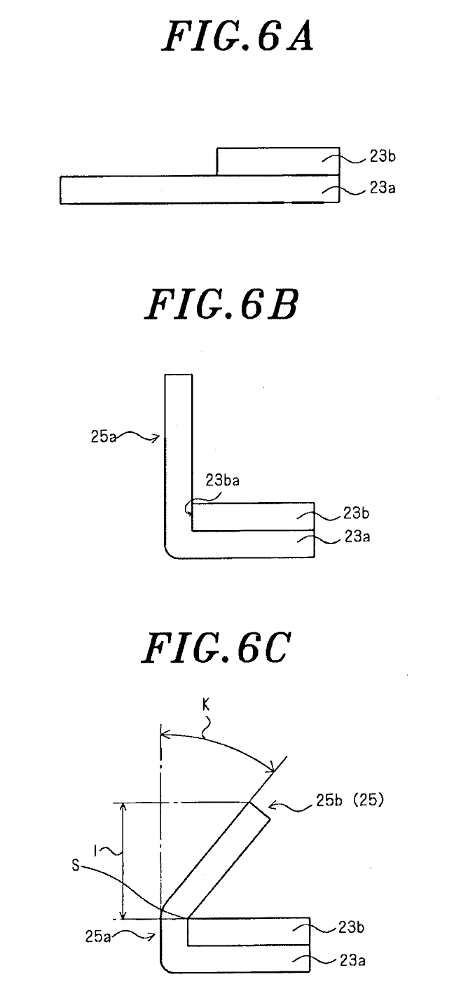

Hereafter, the bridging wire holding jut portion 25 will be described with reference to FIGS. 6A, 6B and 6C. When fabricating the stator core 23, a specified number of (one, in the present embodiment) of the metal sheet 23b is preferably laminated on the metal sheet 23a as illustrated in FIG. 6A so that the teeth 231 can coincide with each other in their positions (the teeth 231 are arranged by laminating the metal sheets 23a and 23b). In this state, the portion of the metal sheet 23a corresponding to the jut portion 25 is preferably bent upwardly at a substantially right angle as illustrated in FIG. 6B so that the upright portion 25a makes contact with the inner circumferential surface 23ba of the metal sheet 23b (the surface of the metal sheet 23b corresponding to the inner circumference 232a of the core-back 232). While the teeth 231 are preferably arranged by laminating two metal sheets as in the case of arranging the stator core 23, they may be arranged from a single metal sheet.

Relative rotation between the metal sheets 23a and 23b is substantially prevented by bringing the upright portion 25a into contact with the inner circumferential surface 23ba of the metal sheet 23b in this manner. Alternatively, the metal sheet 23b may be laminated on the metal sheet 23a after the upright portion 25a is first bent at a right angle with respect to the core-back 232.

Subsequently, as illustrated in FIG. 6C, a bent portion 25b is preferably arranged by bending the leading section of the upright portion 25a from the upper end S of the inner circumferential surface 23ba of the upper metal sheet 23b toward the front surface (upper surface) of the core-back 232 at a predetermined angle K, preferably at about 30 to 40 degrees with respect to the normal line of the metal sheets 23a and 23b. In the present preferred embodiment, the jut portion 25 refers to the bent portion 25b. The metal sheets 23a and 23b are preferably coupled together by causing the upright portion 25a and the resultant bent portion 25b to clasp the metal sheet 23b.

In this regard, the reason for the bending angle of the bent portion 25b being set in the range of from 30 to 40 degrees is to preferably obtain a coupling force great enough to couple the metal sheets 23a and 23b together and to secure a space great enough to hold the bridging wires 242 between the bent portion 25b and the front surface of the core-back 232, i.e., the upper metal sheet 23b.

The vertically projecting size I of the bent portion 25b measured from the top surface of the upper metal sheet 23b is usually determined by the number of the bridging wires 242 held in the bent portion 25b. In general, the projecting size I is preferably set such that the bent portion 25b holds the bridging wires 242 a little greater in number than (e.g., one or two greater than) the ones which are actually held.

For example, if the maximum number of the bridging wires 242 held in the bent portion 25b is three and if the diameter of each of the bridging wires 242 (the diameter of the conductive line 241) is approximately 0.075 to approximately 0.15 mm, the projecting size I is set to enable the bent portion 25b to hold, e.g., four bridging wire 242. Specifically, the projecting size I is set substantially equal to approximately 0.25 to approximately 0.5 mm.

After laminating the metal sheets 23a and 23b, an insulation film (not shown) is arranged on the surfaces of the metal sheets 23a and 23b. Then, the conductive line 241 is preferably wound on the teeth 231. Since the spindle motor 1 of the present preferred embodiment is a three-phase motor, the conductive line 241 is typically wound in three phase at an interval of approximately 120 degrees. As can be seen in FIG. 3, three bridging wires 242 are held on the radial outer side of the jut portion 25.

While the jut portion 25 is preferably bent at a predetermined angle K in the present preferred embodiment, it may be possible employ a construction in which the bridging wires 242 are held by a jut portion not bent but left upright.

Next, the magnetic shield member 26 as a magnetic member of the present preferred embodiment will be described with reference to FIGS. 3, 7 to 10 and 12 to 14.

The substantially ring-shaped magnetic shield member 26 is preferably made of a soft magnetic material that provides a magnetic shield effect. The magnetic shield member 26 is preferably arranged in the small gap axially arranged between the lower one of the disks 4 and the coil layers 24. The magnetic shield effect is proportional to the magnetic permeability of the material used. Use of a material exhibiting high magnetic permeability preferably allows the magnetic shield member 26 to absorb magnetic flux, thereby making it possible to prevent the magnetic flux from passing through the magnetic shield member 26. By virtue of such configuration, the magnetic shield member 26 is preferably made of a metallic magnetic material, one of soft magnetic materials with high magnetic permeability. This preferably ensures that the magnetic flux leaving and entering the coil layers 24 during rotation of the spindle motor 1 is substantially prevented from being leaked upwardly of the magnetic shield member 26 and reaching the head units 6 or the disks 4.

By virtue of such configuration, it becomes possible to eliminate the possibility that the magnetic flux generated from the coil layers 24 affects the disks 4 to thereby cause an error in reading the disks 4 and, in the worst circumstance, to erase the information recorded in the disks 4. It is also possible to substantially eliminate the possibility that the magnetic flux affects and magnetically acts on the head units 6 to thereby crush the head units 6.

The magnetic shield member 26 may be made of any material insofar as it exhibits a magnetic shield effect. For example, the magnetic shield member 26 may be made of martensitic stainless steel, permalloy (Ni alloy) or cemendule (Ni—Co alloy) having a high magnetic permeability. The permalloy and the cemendule efficiently act on a high-frequency alternating magnetic field among others. In the present preferred embodiment, the upwardly flowing component of the magnetic flux generated in the coil layers 24 during rotation of the spindle motor 1 is preferably captured by the magnetic shield member 26 and is returned back to the coil layers 24 after flowing through the magnetic shield member 26. The magnetic shield member 26 is preferably arranged by a single magnetic shield plate or a plurality of axially laminated magnetic shield plates.

The axial positional relationship of the magnetic shield member 26 and the coil layers 24 will be described with reference to FIG. 3. The magnetic shield member 26 is preferably arranged above the coil layers 24 with a specified gap therebetween by fixing the outer edge portion 26a of the magnetic shield member 26 to the outer edge portion 311c of the downwardly recessed generally circular base 311 of the first housing member 31. Alternatively, the magnetic shield member 26 may be directly connected to the upper surfaces of the coil layers 24 by applying an adhesive agent on the lower surface of the magnetic shield member 26. The positional relationship of the magnetic shield member 26 and the coil layers 24 is not particularly limited insofar as the magnetic shield member 26 is capable of covering the upper sides of the coil layers 24 and preventing leakage of the magnetic flux from the coil layers 24.

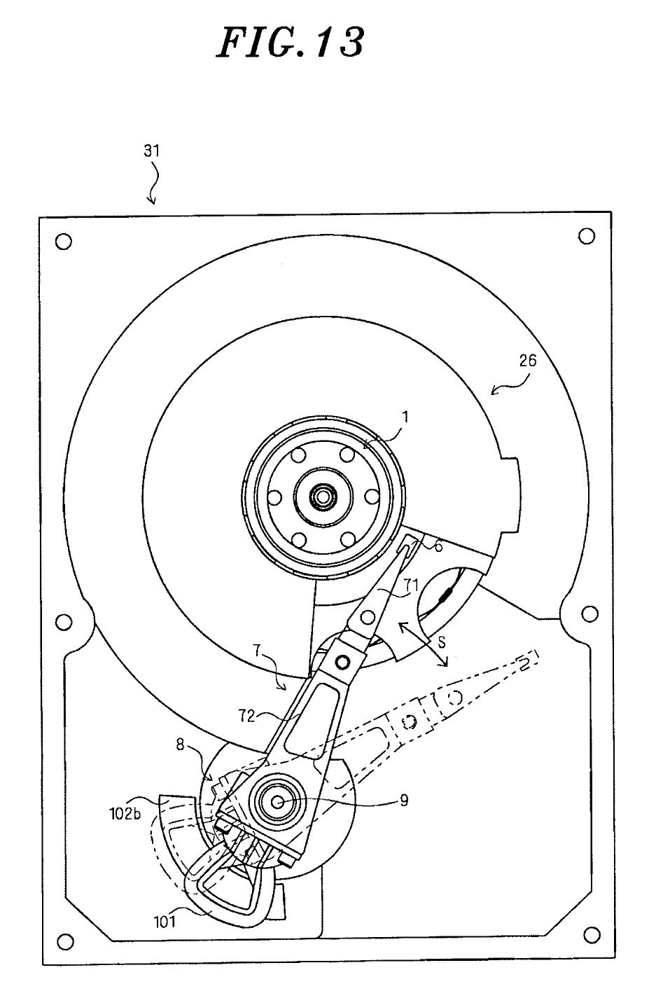

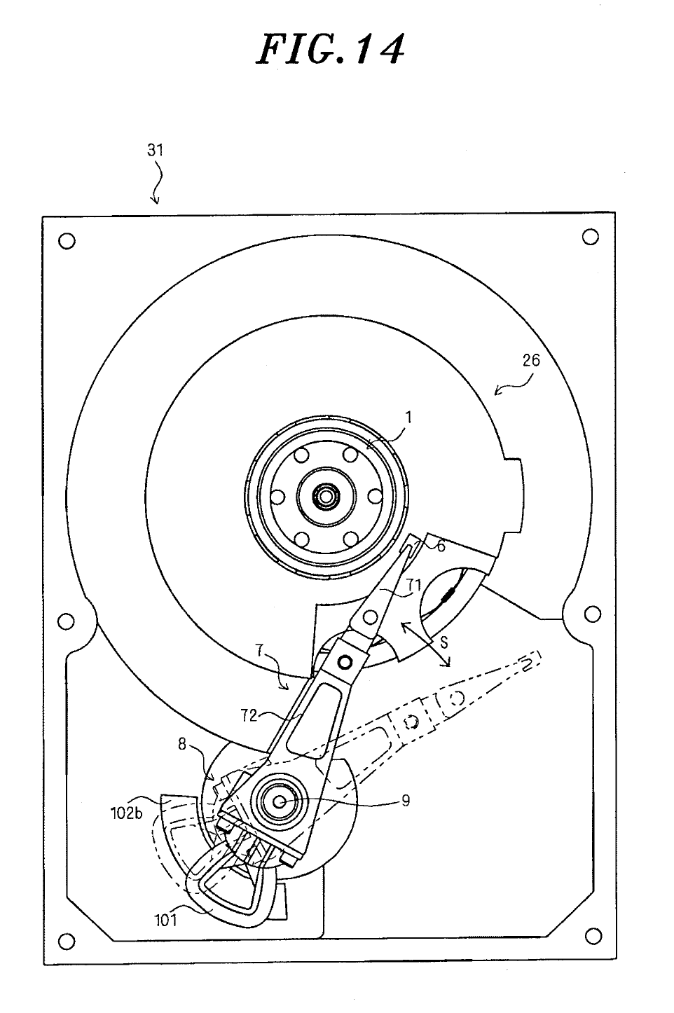

Next, description will be made on the shape of the magnetic shield member 26 according to the present preferred embodiment. As shown in FIGS. 13 and 14, the magnetic shield member 26 of the present preferred embodiment is constructed so that the head units 6 spaced apart from and opposed to the magnetic shield member 26 move radially across the magnetic shield member 26. A radial stepped portion 26b is preferably arranged in the region of the magnetic shield member 26 overlapping with the operating region of the head units 6. A first planar portion 261 and a second planar portion 262 are preferably arranged radially inwardly and outwardly, respectively, of the stepped portion 26b. The first planar portion 261 is preferably arranged nearer to the disks 4 than the second planar portion 262 is (see FIG. 3).

The shape of the first planar portion 261 and the second planar portion 262 is preferably arranged such that the first planar portion 261 extends from the radial inner end toward the stepped portion 26b and the second planar portion 262 extends radially outwardly from the stepped portion 26b. The respective planar portions 261 and 262 preferably have a substantially arc shape when seen in a plan view.

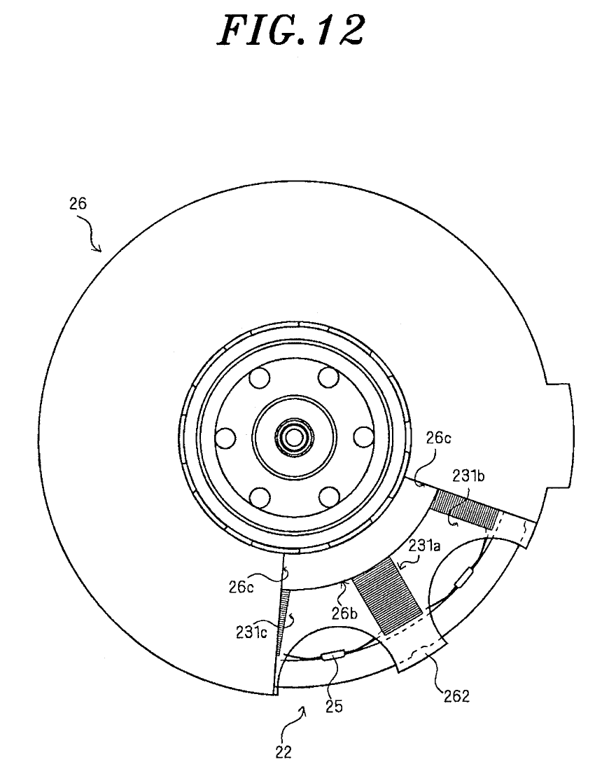

The first planar portion 261 and the second planar portion 262 preferably have such a circumferential area as to allow the lowermost one of the head units 6 to move across the planar portions 261 and 262 (to allow the lowermost one of the carriage units 7 to move over the second planar portion 262). In other words, as shown in FIGS. 12 and 13, the circumferential area of the planar portions 261 and 262 preferably is substantially equal to or greater than the area of the transit region of the head units 6 inclusive of the moving trajectory S of the latter.

By virtue of such configuration, the axial dimension of the stepped portion of the magnetic shield member 26 preferably corresponds to the axial difference in height between the head units 6 and the carriage units 7. Thanks to the provision of the stepped portion, the lowermost one of the head units 6 is preferably accommodated within a gap arranged between the lower one of the disks 4 and the first planar portion 261, while the lowermost one of the carriage units 7 is accommodated within a space defined by the radial outer surface of the first planar portion 261, the upper surface of the second planar portion 262 and the lower surface of the lower one of the disks 4. On the radially extending surface of a conventional magnetic shield member, there is preferably arranged no space great enough to accommodate the lowermost one of the carriage units 7. The construction of the present preferred embodiment described above allows the spindle motor 1 to have an axial dimension smaller than that of the conventional spindle motor, which makes it possible to reduce the thickness and size of the spindle motor 1.

The magnetic shield member 26 has not only the first planar portion 261 and the second planar portion 262, both of which serve as an operating region of the lowermost one of the head units 6, but also a third planar portion 263 arranged outside the operating region of the lowermost one of the head units 6. The first planar portion 261 and the second planar portion 262 are preferably contiguous to the third planar portion 263 in the circumferential direction of the magnetic shield member 26.

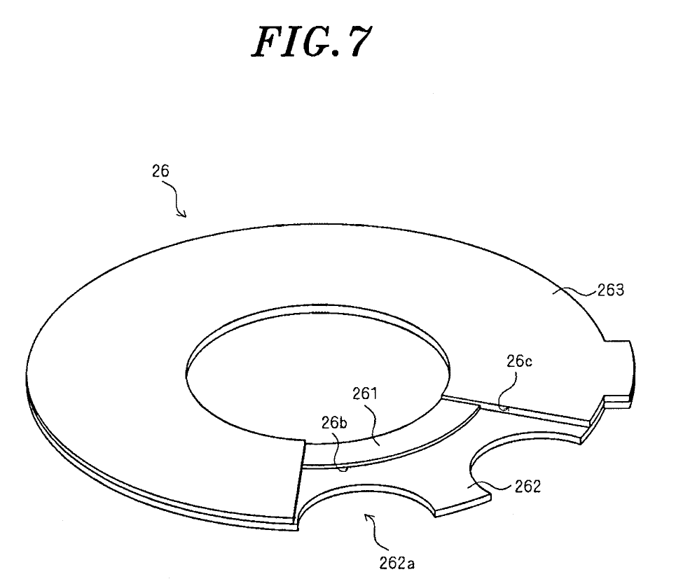

The axial elevation of the first planar portion 261, the second planar portion 262 and the third planar portion 263 will be described with reference to FIG. 7. The second planar portion 262 is axially spaced apart by the greatest distance from the lower one of the disks 4. The third planar portion 263 is positioned higher than the first planar portion 261.

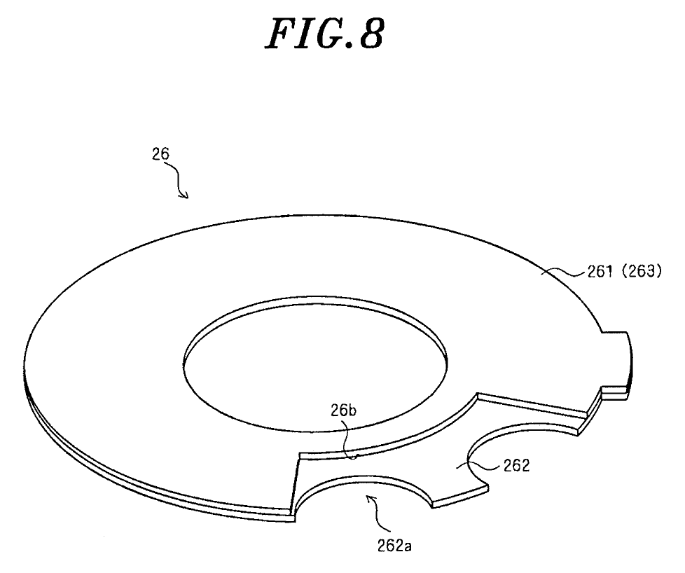

As a modified example, the third planar portion 263 may be arranged on the extension surface of the first planar portion 261 extending from one circumferential end to the other as shown in FIG. 8, so that the third planar portion 263 can be flush with the first planar portion 261.

It is to be noted that the stepped portions 26b and 26c of the magnetic shield member 26 do not necessarily have a slope shape or a right-angled shape.

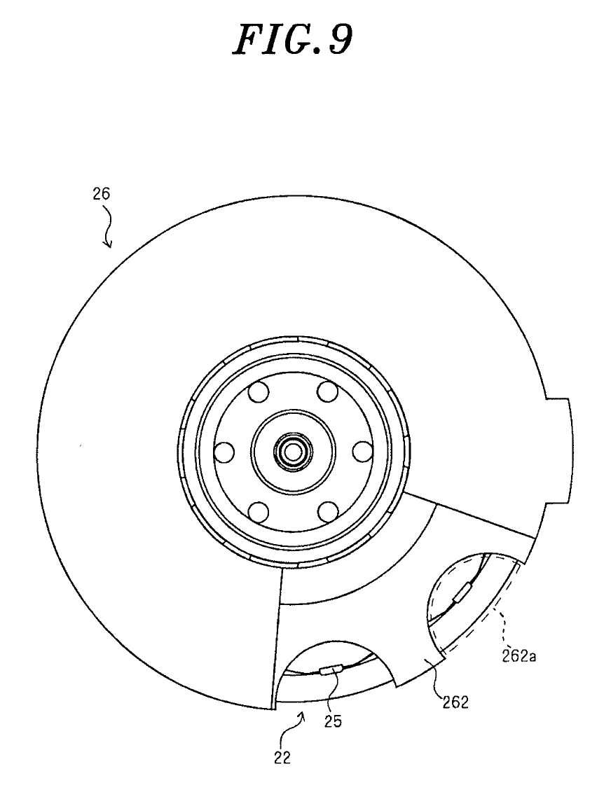

Next, the second planar portion 262 of the magnetic shield member 26 will be described in more detail with reference to FIGS. 3 and 9. The stator 22 is preferably arranged below the magnetic shield member 26. Particularly, the bridging wire holding jut portion 25 is preferably arranged underneath the second planar portion 262. As described above, the jut portion 25 protrudes upwardly (toward the magnetic shield member 26) from the core-back 232 of the stator 22. In view of this, a cutout portion 262a is preferably arranged in the region of the second planar portion 262 overlapping with the jut portion 25, so that the jut portion 25 and the second planar portion 262 do not make contact with each other. Consequently, the tip end of the jut portion 25 is preferably inserted into or penetrates the cutout portion 262a, which makes it possible to arrange the second planar portion 262 axially below the tip end of the jut portion 25. By virtue of such configuration, it becomes possible to reduce the thickness of the motor.

In the present preferred embodiment, as shown in FIG. 9, the cutout portion 262a is preferably arranged by cutting away the region of the second planar portion 262 that extends from the outer peripheral edge thereof to the position overlapping with the jut portion 25. However, the present invention is not limited thereto. As an alternative example, it may be possible to employ a construction in which a through-hole is arranged in the position of the second planar portion 262 substantially overlapping with the jut portion 25, the tip end of the jut portion 25 being allowed to protrude through the through-hole. The cutout portion 262a or the through-hole may have any shape insofar as it allows the jut portion 25 to vertically upwardly penetrate therethrough.

Next, description will be made on the relationship between the cutout portion 262a of the magnetic shield member 26 and the magnetic flux generated from the coil layers 24 (the stator 22). The portion of the stator 22 where the magnetic flux is generated in the greatest quantity is the portion near the central axis of the teeth 231 radially opposed to the rotor magnet 17. The jut portion 25 of the stator 22 is preferably arranged in a position near the radial outer portion of the teeth 231 distant from the rotor magnet 17. This position is also distant from the head units 6. Therefore, the head units 6 are hardly affected by the magnetic flux leaked from the cutout portion 262a.

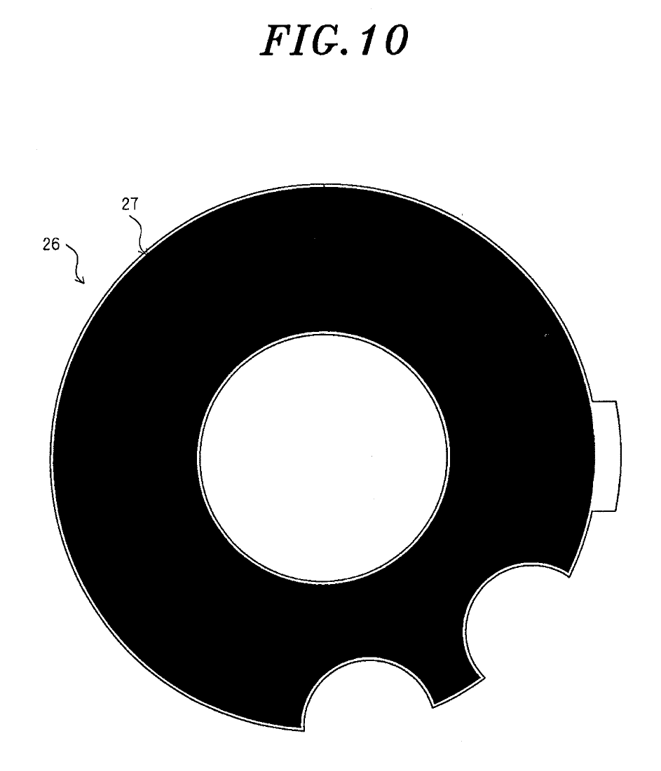

As shown in FIG. 10, an insulation layer 27 is preferably coated on the lower surface of the magnetic shield member 26. By coating the insulation layer 27 on the magnetic shield member 26 which is electrically conductive, it becomes possible to electrically isolate the magnetic shield member 26 and the coil layers 24, thereby preventing occurrence of short circuit which would otherwise be caused by metal-to-metal contact therebetween.

As the material of the insulation layer 27, it is possible to use, e.g., an epoxy-based resin, a polyimide-based resin, a polyester-based resin, a polyethersulfone-based resin, an acrylic resin or the like. As a method to arrange the insulation layer 27, it is possible to use a method in which a sheet-like insulation film, one surface of which is applied with an adhesive agent such as a pressure sensitive adhesive or the like, is bonded to the surface of the magnetic shield member 26. While the insulation film is preferably bonded to the magnetic shield member 26 by use of an adhesive agent such as a pressure sensitive adhesive or the like in the present preferred embodiment, a double-sided adhesive tape may be used in bonding the insulation film to the magnetic shield member 26. As an alternative method, the insulation layer 27 may be coated by applying a molten resin on the surface of the magnetic shield member 26 and curing the same. The area of the insulation layer 27 is set substantially equal to or smaller than the area of the magnetic shield member 26.

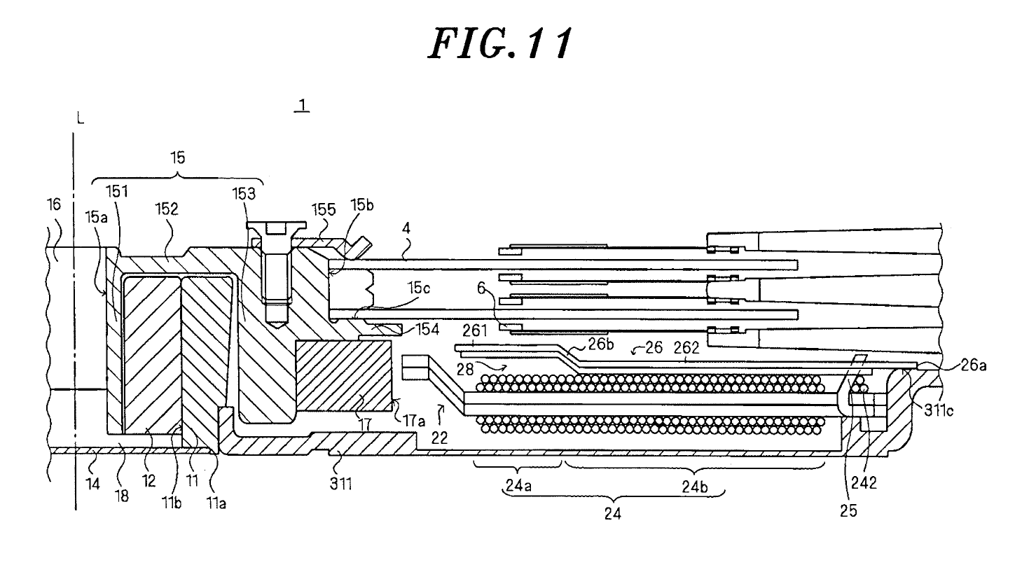

The thickness of the coil layers 24 arranged by winding the conductive line 241 on the teeth 231 will be described with reference to FIGS. 3 and 11. Note that the description will be made on a case where the coil layers 24 are uniform in thickness and a case where the coil layers 24 are not uniform in thickness. As shown in FIG. 5, the stator core 23 of the present preferred embodiment includes nine teeth 231 arranged around the central axis. Although one of the teeth 231 is shown in FIGS. 3 and 11 which are referred to in the following description, it is to be understood that the remaining teeth 231 have the same construction unless specifically mentioned otherwise.

First, an instance where the coil layers 24 are radially uniform in thickness will be described with reference to FIG. 11. More specifically, each of the coil layers 24 arranged at least in the operating region of the head units 6 preferably include an inner coil layer 24a wound on the portion of the teeth 231 opposed to the first planar portion 261 and an outer coil layer 24b wound on the portion of the teeth 231 opposed to the second planar portion 262, the maximum thickness of the inner coil layer 24a being substantially equal to the maximum thickness of the outer coil layer 24b. Therefore, a space 28 is preferably arranged between the first planar portion 261 of the magnetic shield member 26 and the inner coil layer 24a. By virtue of such configuration, it becomes possible to prevent the conductive line 241 from suffering from reduction in the pressure resistance. Otherwise, the conductive line 241 would be severed because it is unable to resist the pressure acting downwardly when the magnetic shield member 26 is fixed to the upper surfaces of the coil layers 24 wound on the teeth 231.

Next, an instance where the coil layers 24 are radially non-uniform in thickness will be described with reference to FIG. 3. As described above, the magnetic shield member 26 of the present preferred embodiment preferably includes the stepped portion 26b arranged in the radial direction, the first planar portion 261, and the second planar portion 262 arranged lower than the conventional shield member. In the present preferred embodiment, each of the coil layers 24 is preferably made radially non-uniform in conformity with the shape of the magnetic shield member 26.

Each of the coil layers 24 on the teeth 231 arranged at least in the operating region of the head units 6 preferably includes an inner coil layer 24a wound on the portion of the teeth 231 opposed to the first planar portion 261 and an outer coil layer 24b wound on the portion of the teeth 231 opposed to the second planar portion 262. The coil layers 24 are preferably arranged by winding the conductive line 241 on the teeth 231 so that the maximum thickness of the inner coil layer 24a can be greater than the maximum thickness of the outer coil layer 24b.

In the present preferred embodiment, the inner coil layer 24a is preferably arranged by winding four layers of the conductive line 241 on the portion of each of the teeth 231 opposed to the first planar portion 261. On the remaining portion of each of the teeth 231 opposed to the second planar portion 262, the conductive line 241 electrically connected to the inner coil layer 24a is preferably wound into two layers to arrange the outer coil layer 24b.

When the coil layers 24 are arranged by winding the conductive line 241 on the teeth 231, the winding number of the inner coil layer 24a is increased in the portion of each of the teeth 231 opposed to the first planar portion 261, but the winding number of the outer coil layer 24b is reduced in the remaining portion of each of the teeth 231 opposed to the second planar portion 262. However, the total winding number of the coil layers 24 wound on the teeth 231 is equal to the winding number of the coil layers 24 as in the conventional spindle motors. By virtue of such configuration, it becomes possible to make radially non-uniform the coil layers 24 wound on the teeth 231, while maintaining the torque to rotate the rotor unit 13 about the central axis.

Next, the positional relationship of the inner coil layer 24a and the outer coil layer 24b relative to the magnetic shield member 26 when the magnetic shield member 26 is bonded to the stator 22 with an adhesive agent or the like will be described with reference to FIG. 3.

The coil layers 24 are preferably constructed so that the boundary portion 24c between the inner coil layer 24a and the outer coil layer 24b can axially adjoin to the stepped portion 26b of the magnetic shield member 26, when the magnetic shield member 26 is placed over the inner coil layer 24a and the outer coil layer 24b. By virtue of such configuration, the coil layers 24 are moved nearer to the central axis than the conventional configuration, in proportion to which the magnetic shield member 26 can be moved axially downwardly. Consequently, it becomes possible to reduce the thickness and size of the spindle motor while keeping the torque thereof unchanged.

As shown in FIG. 12, the stepped portion 26b of the magnetic shield member 26 is preferably arranged radially upwardly of the tooth 231a. Coil layers differing in thickness from each other are preferably arranged on the radial inner extension and the radial outer extension of the tooth 231a. Radially non-uniform coil layers are also arranged in the teeth 231b and 231c lying below the stepped portion 26b between the first planar portion 261 and the second planar portion 262 and also below the stepped portions 26c between the first planar portion 261, the second planar portion 262 and the third planar portion 263.

While the coil layers 24 of the teeth 231 positioned near at least the operating region of the head units 6 have been described in the present preferred embodiment, the present invention is not limited thereto. For example, the same construction may be employed in all of the coil layers wound on the respective teeth.

In the present preferred embodiment, the inner coil layer 24a is preferably wound into four layers on the portion of each of the teeth 231 opposed to the first planar portion 261, and the outer coil layer 24b is wound into two layers on the portion of each of the teeth 231 opposed to the second planar portion 262. However, the present invention is not limited thereto. For example, the inner coil layer 24a may be wound into five layers, and the outer coil layer 24b may be wound into a single layer.

The configuration of the magnetic shield member 26 with the stepped portions may be modified in many different forms. For example, one magnetic shield member may be constructed by independently arranging the first planar portion, the second planar portion and the third planar portion and then laminating them together. As a further example, the magnetic shield member may be constructed by axially laminating one or more magnetic shield plates and then may be bent by pressing or other plastic working to thereby arrange the first planar portion, the second planar portion and the third planar portion.

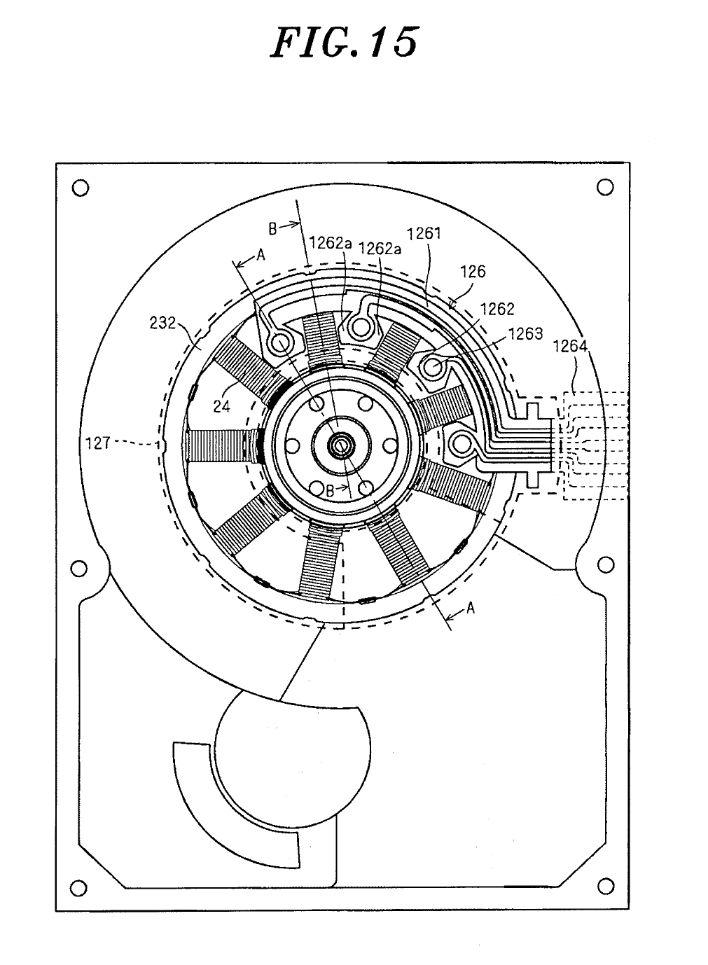

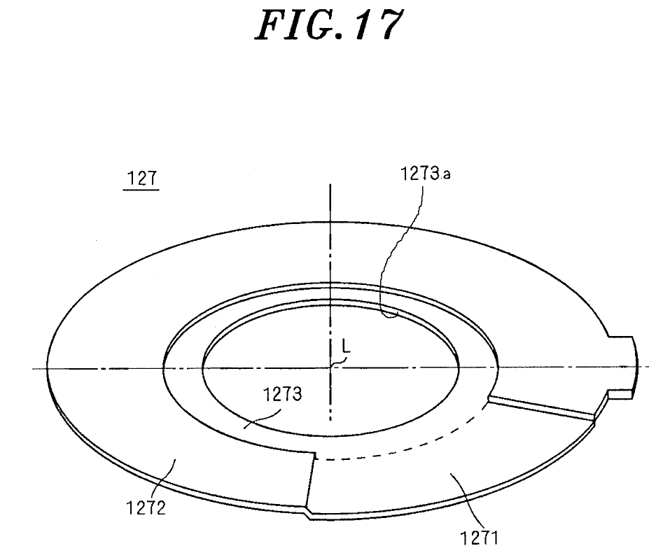

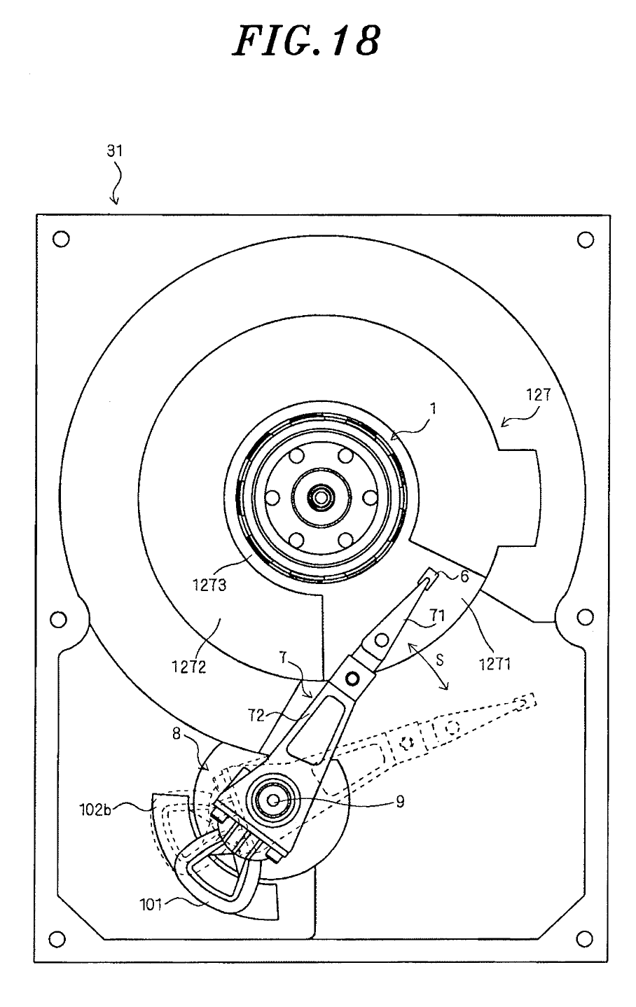

Next, another preferred embodiment of the present invention will be described with reference to FIGS. 15 through 20. The basic construction of the spindle motor and the disk drive apparatus provided with the same is identical with that of the preceding preferred embodiment.

A flexible printed circuit board 126 (hereinafter referred to as “FPC 126”) is preferably fixed in place so that it can make contact with the upper surface of the coil layers 24 or the core-back 232. The conductive lines leading from the coil layers 24 (hereinafter referred to as “lead lines”) are preferably conducted to the FPC 126 and then affixed to the electrodes (the below-mentioned land portions 1264) of the FPC 126 by soldering or the like. As an electric current is preferably supplied from an external power source (not shown) to the stator 22 through the FPC 126, magnetic flux is generated in the stator 22 and torque is generated by the magnetic interaction between the magnetic flux and the rotor magnet 17 to thereby rotatingly drive the motor 1.

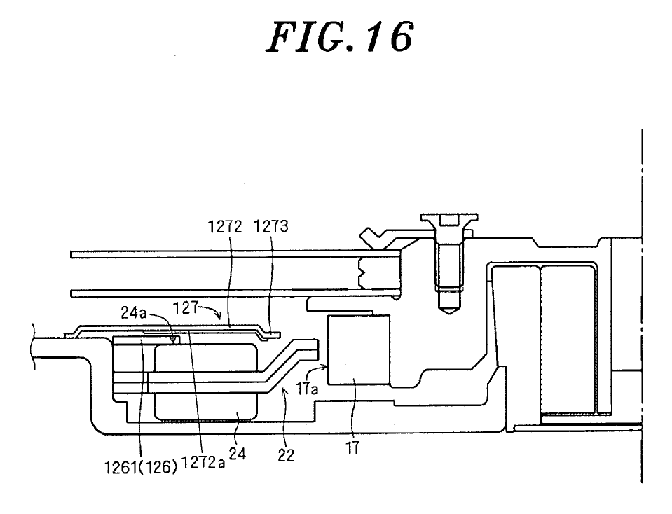

Hereinafter, the construction of the FPC 126 will be described with reference to FIGS. 15 and 16. FIG. 15 is a top plan view of the disk drive apparatus corresponding to FIG. 2, with the disks removed for clarity. FIG. 16 is a sectional view taken along line B-B in FIG. 15.

The FPC 126 preferably includes a main body portion 1261, electric connection portions 1262 and external connection portions 1263. Land portions 1264 made of a copper foil or the like are preferably arranged on the surface of the FPC 126.

More specifically, the main body portion 1261 is preferably fixed to the upper surface of the coil layers 24 or the core-back 232. The main body portion 1261 preferably includes a substantially arc shape and extends along the substantially ring-shaped core-back 232. The main body portion 1261 preferably extends in the circumferential direction to interconnect the radial outer end portions of the electric connection portions 1262. In the present preferred embodiment, the main body portion 1261 is preferably fixed to the upper surfaces 24a of the coil layers 24 as shown in FIG. 16. Each of the electric connection portions 1262 preferably includes a pair of circumferentially extending bulge portions 1262a on its opposite sides. Each of the electric connection portions 1262 is preferably arranged between the neighboring teeth 231, i.e., between the neighboring coil layers 24. The lead lines leading from the coil layers 24 of the stator 22 are preferably electrically connected to the electric connection portions 1262.

Inasmuch as the spindle motor 1 of the present preferred embodiment is a three-phase driving motor, the electric connection portions 1262 preferably includes four connection portions, i.e., a U-phase connection portion, a V-phase connection portion, a W-phase connection portion and a common connection portion. The land portions 1264 leading from the respective electric connection portions 1262 are preferably connected to the electric connection portions 1262 via the main body portion 1261. The electric connection portions 1262 preferably extend downwardly through the base 311 and are fixed to the lower surface of the base 311. An electric current is preferably supplied from an external power source to the electric connection portions 1262 and then to the coil layers 24 via the land portions 1264 and the electric connection portions 1262.

Next, the magnetic member of the present preferred embodiment, i.e., a magnetic shield member 127, will be described with reference to FIGS. 16 through 20.

The constituent material and basic function of the magnetic shield member 127 is substantially the same as described in respect of the preceding preferred embodiment. In the present preferred embodiment, description will be focused on the parts differing from those of the preceding preferred embodiment.

The outer edge portion of the magnetic shield member 127 is preferably fixed to the outer edge portion of the base 311. An adhesive agent is preferably applied on the lower surface of the magnetic shield member 127. Then the lower surface of the magnetic shield member 127 is directly connected to the upper surfaces 24a of the coil layers 24. Alternatively, the magnetic shield member 127 may be arranged above the coil layers 24 with a specified gap therebetween. The magnetic shield member 127 and the coil layers 24 may have any positional relationship as long as the magnetic shield member 127 covers the upper sides of the coil layers 24 and prevents the magnetic flux from being leaked from the coil layers 24.

Next, description will be made on the shape of the magnetic shield member 127 of the present preferred embodiment. The magnetic shield member 127 of the present preferred embodiment preferably includes a second planar portion 1271 arranged with a planar surface extending generally perpendicularly to the central axis L and arranged in a region corresponding to the movement region of the head units 6, a third planar portion 1272 circumferentially adjoining to the second planar portion 1271 and positioned higher than the second planar portion 1271, and a first planar portion 1273 arranged radially inwardly of the second planar portion 1271 and the third planar portion 1272 and arranged to have a uniform axial height. Specifically, the first planar portion 1273 is preferably arranged lower than the third planar portion 1272 and is flush with the second planar portion 1271, as can be seen in FIG. 16.

With this construction, the inner circumferential surface 1273a of the magnetic shield member 127, i.e., the inner circumferential surface 1273a of the first planar portion 1273, spaced apart from and opposed to the outer circumferential surface 17a of the rotor magnet 17, is preferably arranged uniformly in the circumferential direction. This stabilizes the magnetic attraction force in the course of rotatingly driving the motor 1, which in turn assures stable rotation of the rotor unit 13 and makes it possible to prevent occurrence of defects such as a positioning error signal, a puretone and a repeatable run-out.

It is to be noted that the stepped portions arranged in the boundaries of the second planar portion 1271, the third planar portion 1272 and the first planar portion 1273 of the magnetic shield member 127 do not necessarily have a slope shape or a right-angled shape.

Next, the relationship between the magnetic shield member 127 and the FPC 126 will be described with reference to FIGS. 15 and 16.

Description will be made first on the construction of the electric connection portions 1262 of the FPC 126, in which construction the electric connection portions 1262 extending from the radial inner ends to the radial outer ends thereof are downwardly bent into a slanting shape with the radial outer end of the main body portion 1261 used as a fulcrum.

As shown in FIG. 15, the circumferential width of each of the electric connection portions 1262 having the bulge portions 1262a on the opposite sides thereof is preferably set substantially equal to or smaller than the circumferential width of the gap between the neighboring teeth 231, namely between the neighboring coil layers 24. Each of the electric connection portions 1262 is preferably bent into a slanting shape when seen in a sectional view and is arranged between the neighboring teeth 231, namely between the neighboring coil layers 24. This construction makes it possible to arrange the bulge portions 1262a of the electric connection portions 1262 alongside the coil layers 24 and also to electrically connect the lead lines leading from the coil layers 24 to the land portions 1264 of the electric connection portions 1262 in a reliable manner.

Since the third planar portion 1272 of the magnetic shield member 127 is preferably positioned higher than the second planar portion 1271 and the first planar portion 1273, a space is preferably arranged between the upper surfaces 24a of the coil layers 24 and the lower surface 1272a of the third planar portion 1272. After applying an adhesive agent on the lower surface of the second planar portion 1271 of the magnetic shield member 127, the magnetic shield member 127 is arranged on the upper surfaces 24a of the coil layers 24. When the magnetic shield member 127 has been fixed to the coil layers 24, the main body portion 1261 of the FPC 126 is positioned in the afore-mentioned space as shown in FIG. 16. This construction makes it possible to reduce the thickness of the spindle motor 1, while allowing the inner circumferential surface 1273a of the magnetic shield member 127, i.e., the inner circumferential surface 1273a of the first planar portion 1273, to have a uniform circumferential shape. Alternatively, a part of the electric connection portions 1262 as well as the main body portion 1261 of the FPC 126 may be arranged within the afore-mentioned space.

The FPC 126 is effectively held in the stator 22 by adhesively fixing the main body portion 1261 of the FPC 126 to the upper surfaces 24a of the coil layers 24 and adhesively fixing the side surfaces of the electric connection portions 1262 of the FPC 126 to the side surfaces of the coil layers 24.

By fixing the FPC 126 in this manner, it becomes possible to maintain the FPC 126 in the fixed position even when an external shock is applied thereto. This eliminates the possibility that the conductive line 241 of the coil layers 24 being dislocated and damaged.

Next, description will be made on an instance where the main body portion 1261 of the FPC 126 is flush with the electric connection portions 1262.

In such an instance, the circumferential width of each of the electric connection portions 1262 having the bulge portions 1262a on the opposite sides thereof may be set greater than the circumferential width of the gap between the neighboring teeth 231, namely between the neighboring coil layers 24. This is because the main body portion 1261 of the FPC 126 is flush with the electric connection portions 1262. In that case, the electric connection portions 1262 and the bulge portions 1262a are allowed to make contact with the upper surfaces 24a of the coil layers 24. This makes it possible to electrically connect the lead lines leading from the coil layers 24 to the land portions 1264 in a reliable manner.

In order to reduce the thickness of the spindle motor 1, it is preferred that the main body portion 1261 of the FPC 126 and the electric connection portions 1262 are arranged within the space defined between the lower surface 1272a of the third planar portion 1272 of the magnetic shield member 127 and the upper surfaces 24a of the coil layers 24. To this end, the sum total of the radial width of the main body portion 1261 of the FPC 126 and the radial width of the electric connection portions 1262 is set substantially equal to or smaller than the radial width of the second planar portion 1271 of the magnetic shield member 127.

The second planar portion 1271 preferably includes a substantially sector-like shape and extends radially from the radial inner side to the radial outer side. Furthermore, the second planar portion 1271 preferably includes a circumferential width great enough to allow the head units 6 to make free swinging movement. The circumferential width of the second planar portion 1271 is substantially equal to or greater than the width of the transit region of the head units 6 inclusive of the swinging trajectory S of the latter.

As in the preceding preferred embodiment, an insulation layer is preferably arranged on the lower surface of the magnetic shield member 127. It is preferred that the insulation layer is coated on at least the region of the lower surface of the magnetic shield member 127 axially opposed to the coil layers 24. Needless to say, the insulation layer may be coated over the region equivalent to the area of the lower surface of the magnetic shield member 127. The second planar portion 1271, the third planar portion 1272 and the first planar portion 1273 of the magnetic shield member 127 differ in axial height from one another. Therefore, the insulation layer is preferably coated on the lower surface of the magnetic shield member 127 in such a manner as to conform to the axial height of the second planar portion 1271, the third planar portion 1272 and the first planar portion 1273.

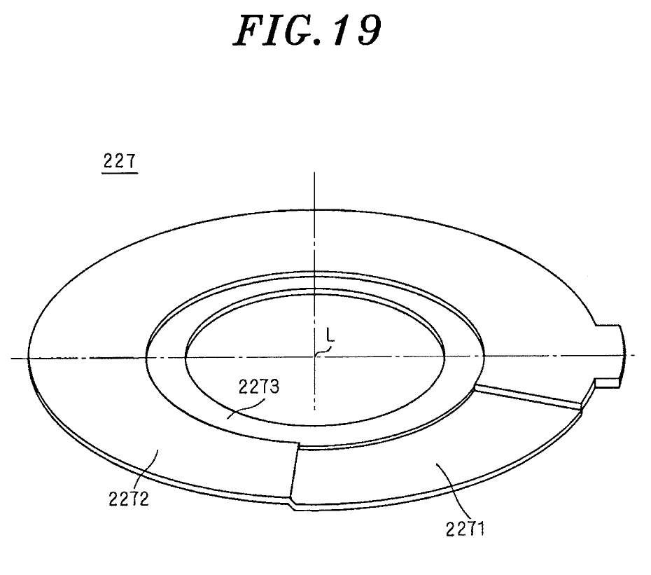

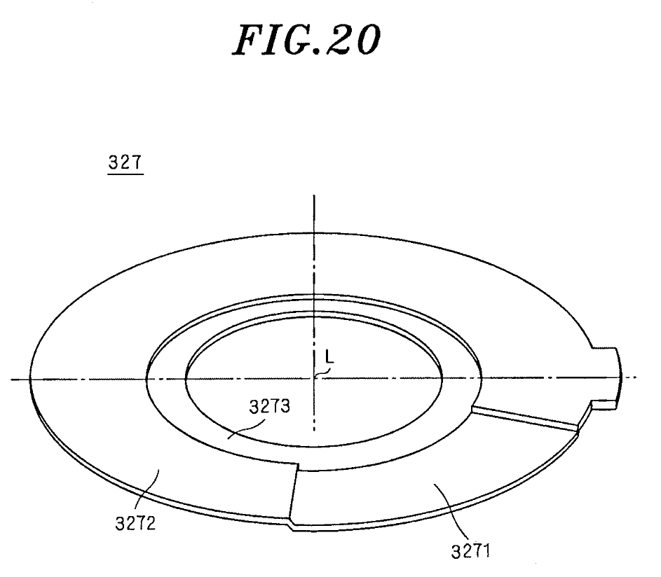

As a modified example, the magnetic shield member 227 shown in FIG. 19 is preferably constructed so that a first planar portion 2273 can be positioned lower than a third planar portion 2272 but higher than a second planar portion 2271. As another modified example, the magnetic shield member 327 shown in FIG. 20 is preferably constructed so that a first planar portion 3273 can be positioned lower than a second planar portion 3271 which in turn is lower than a third planar portion 3272.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A spindle motor for a disk drive apparatus including a head unit arranged to read and/or write information from and/or on a disk and a moving unit arranged to move the head unit across the disk, the spindle motor comprising:
a rotor unit rotatably supported by a bearing portion and arranged to rotate about a central axis, the rotor unit including a rotor magnet and a disk mounting portion arranged to have the disk mounted thereon;
a stator radially opposed to the rotor magnet with a gap therebetween, the stator including a plurality of teeth radially arranged around the central axis and a plurality of coil layers defined by a conductive line wound on the teeth; and
a generally ring-shaped magnetic member arranged within an axial gap formed between the disk and the coil layers; wherein
the head unit is adapted to be opposed to the magnetic member in a spaced-apart relationship and is adapted to radially move over the magnetic member; and
the magnetic member includes a first planar portion and a second planar portion located in a region overlapping with a moving region of the head unit, the first planar portion and the second planar portion differ in axial height from each other, and the first planar portion is positioned higher than the second planar portion.

2. The spindle motor of claim 1, wherein the first planar portion is positioned radially inwardly of the second planar portion.

3. The spindle motor of claim 1, wherein the magnetic member further includes a stepped portion arranged to interconnect the first planar portion and the second planar portion.

4. The spindle motor of claim 1, wherein at least the coil layers positioned near the head unit include an inner coil layer wound on the portion of each of the teeth opposed to the first planar portion and an outer coil layer wound on the portion of each of the teeth opposed to the second planar portion, and the inner coil layer has a maximum thickness greater than a thickness of the outer coil layer.

5. The spindle motor of claim 4, wherein a boundary portion is located between the inner coil layer and the outer coil layer, and the boundary portion is axially adjacent to a stepped portion of the magnetic member.

6. The spindle motor of claim 4, wherein each of the coil layers wound on the teeth includes an inner coil layer and an outer coil layer, and the inner coil layer has a maximum thickness greater than a thickness of the outer coil layer.

7. The spindle motor of claim 1, wherein each of the coil layers has a radially uniform thickness and a space provided between the first planar portion of the magnetic member and the coil layers.

8. The spindle motor of claim 1, wherein the stator further includes a ring-shaped core-back arranged to electrically interconnect radial outer ends of the teeth, the core-back has an upwardly protruding portion, and the second planar portion of the magnetic member has a cutout portion arranged in a position corresponding to the protruding portion.

9. The spindle motor of claim 1, wherein the magnetic member further includes a third planar portion positioned outside the moving region of the head unit, and the first planar portion and the second planar portion circumferentially adjoin to the third planar portion.

10. The spindle motor of claim 9, wherein the third planar portion is positioned higher than the first planar portion.

11. The spindle motor of claim 9, wherein the third planar portion is substantially axially flush with the first planar portion.

12. A disk drive apparatus for rotating a disk, comprising:
a head unit arranged to read and/or write information from and/or on the disk;
a moving unit arranged to move the head unit across the disk;
a base member; and
the spindle motor of claim 1 provided within the base member.

13. A spindle motor for a disk drive apparatus including a head unit arranged to read and/or write information from and/or on a disk and a moving unit arranged to move the head unit across the disk, the spindle motor comprising:
a rotor unit rotatably supported by a bearing portion and arranged to rotate about a central axis, the rotor unit including a rotor magnet and a disk mounting portion arranged to have the disk mounted thereon;
a stator radially opposed to the rotor magnet with a gap therebetween, the stator including a plurality of teeth radially arranged around the central axis and a plurality of coil layers defined by a conductive line wound on the teeth; and
a generally ring-shaped magnetic member arranged within a gap formed axially between the disk and the coil layers; wherein
the head unit is adapted to be opposed to the magnetic member in a spaced-apart relationship and is adapted to radially move over the magnetic member; and
the magnetic member includes a ring-shaped first planar portion having a planar surface extending generally perpendicularly to the central axis, and the first planar portion has an axial height generally uniform in a circumferential direction; a second planar portion arranged in a region overlapping with a moving region of the head unit and positioned radially outwardly of the first planar portion; and a third planar portion circumferentially adjoining to the second planar portion, and the third planar portion is positioned radially outwardly of and axially higher than the first planar portion.

14. The spindle motor of claim 13, wherein the stator further includes a ring-shaped core-back arranged to circumferentially electrically interconnect radial outer ends of the teeth, and a flexible printed circuit board including a plurality of electric connection portions arranged between the teeth, the conductive wire being electrically connected to the electric connection portions, and a generally arc-shaped main body portion circumferentially extending to interconnect radial outer ends of the electric connection portions; wherein
at least the main body portion of the flexible printed circuit board is arranged axially between the third planar portion and the coil layers.

15. The spindle motor of claim 14, wherein a sum total of a radial width of the main body portion of the flexible printed circuit board and a radial width of the electric connection portions is equal to or smaller than a radial width of the third planar portion of the magnetic member.

16. The spindle motor of claim 13, wherein the first planar portion and the second planar portion are substantially axially flush with each other.

17. The spindle motor of claim 13, wherein the second planar portion is axially lower than the third planar portion.

18. The spindle motor of claim 17, wherein the second planar portion is axially lower than the first planar portion.

19. The spindle motor of claim 17, wherein the first planar portion is axially lower than the second planar portion.

20. A disk drive apparatus for rotating a disk, comprising:
a head unit arranged to read and/or write information from and/or on the disk;
a moving unit arranged to move the head unit across the disk;
a base member; and
the spindle motor of claim 13 provided within the base member.
